(19) United States
(12) Patent Application Publication
(10) Pub. No.: US 2024/0359416 A1
(43) Pub. Date: Oct. 31, 2024

(54) TIRE CURING PRESS AND A METHOD FOR CURING TIRES

(71) Applicant: LARSEN & TOUBRO LIMITED, Veda (IN)

(72) Inventors: Ganesh Raja KARUPPUSAMY, Vedal (IN); Suresh RAJENDRAN, Vedal (IN); Danie V M, Vedal (IN); Santhosh Kumar DURAISAMY, Vedal (IN); Prabu MANI, Vedal (IN); Srikanth JAGANNATHAN, Vedal (IN); Kamalraj U K, Vedal (IN); Mano KAMARAJ, Vedal (IN); Vigneshwaran GUNASUNDARAM, Vedal (IN); Ashokkumar MANIKANDAN, Vedal (IN); Sundarraj G, Vedal (IN); Ruchita A, Vedal (IN); Vignesh CHANDRASEKARAN, Vedal (IN)

(21) Appl. No.: 18/139,970

(22) Filed: Apr. 27, 2023

(51) Int. Cl. B29D 30/06; B29C 33/20

(52) U.S. Cl. CPC B29D 30/0605; B29C 33/202; B29D 30/0662

(57) ABSTRACT

A tire curing press includes a top structure and a bottom structure. Hollow squeeze cylinders that can be extended and retracted are mounted underside of the bottom structure. Squeeze columns are mounted inside respective hollow pistons that can slide inside respective cylinders. Grooves are formed at intermediate position on the columns to obtain variable heights between the top and bottom structures. Lock assemblies are assembled concentric to each column above the top structure. The lock assemblies have clamping plates capable of being pulled towards each other to engage with the grooves and to lock the top structure with the columns. Distance sensors are provided to determine a distance between the grooves of each column and the clamping plates when the squeeze cylinders are retracted. Control means are configured to independently disengage the clamping plates from the grooves of each column when a predetermined distance is sensed by the distance sensors.

### TECHNICAL FIELD

The present invention relates to tire curing presses, and more particularly to hydraulic tire curing presses and methods for curing tires.

### BACKGROUND

In a tire curing press, green tire refers to an uncured state of tire which is placed in special molds where all patterns and side wall branding of the tire occurs during its curing. The mold is composed of a top half and a bottom half which are fastened within structures of the tire curing press. There are two types of tire curing presses depending on the methods to maintain the pressure on the molds, such as—namely Mechanical Tire Curing Press (MTCP) and Hydraulic Tire Curing Press (HTCP). In MTCPs, the top mold is locked onto the bottom mold mechanically by a bull gear and an internal pressure is maintained. In HTCPs, the mold is kept under pressure continuously by an individual or a plurality of hydraulic cylinder. The size, weight, and complexity of mechanical tire curing presses result in very high manufacturing, transportation, and installation costs. Hence, a great number of different hydraulic actuated tire curing presses have evolved

### SUMMARY

Some aspects of the disclosure relate to a tire curing press, including a top structure and a bottom structure. A first hollow cylinder is mounted below the bottom structure and is capable of being extended during curing and retracted post-curing of a tire. A second hollow cylinder is mounted below the bottom structure at a fixed distance from the first hollow cylinder, and is capable of being extended during curing and retracted post-curing of a tire. A first column has a lower end mounted inside a first hollow piston slidably mounted inside the first hollow cylinder. A second column has a lower end mounted inside a second hollow piston slidably mounted inside the second hollow cylinder. The top structure is capable of sliding along the first and second columns in a direction towards or away from the bottom structure. Height adjustment grooves are formed at an intermediate position on each of the first and second columns to obtain variable heights between the top and bottom structures and to accommodate different sizes of tire molds. A first lock assembly is assembled concentric to the first column above the top structure and a second lock assembly is assembled concentric to the second column above the top structure. Each of the first and second lock assemblies includes clamping plates capable of being pulled towards each other to engage with the height adjustment grooves and to lock the top structure with the first and second columns during curing. A first distance sensor determines a distance between the height adjustment grooves of the first column and the clamping plates of the first lock assembly when the first hollow cylinder is retracted post-curing of the tire. A second distance sensor determines a distance between the height adjustment grooves of the second column and the clamping plates of the second lock assembly when the second hollow cylinder is retracted post-curing of the tire. A first control means disengages the clamping plates from the height adjustment grooves of the first column when a predetermined distance is sensed by the first distance sensor. A second control means disengages the clamping plates from the height adjustment grooves of the second column when a predetermined distance is sensed by the second distance sensor.

Some other aspects of the disclosure relate to a method for vulcanizing tires using the tire curing press including: positioning an uncured tire between an upper tire mold and a lower tire mold of a tire curing press; closing the tire curing press by lowering the top structure and engaging the clamping plates of the first and second lock assemblies to the height adjustment grooves of the first and second column; creating hydraulic oil pressure along inner walls of the first and second hollow cylinders to push first and second hollow pistons downward and pull the first and second columns and the top structure downwards to squeeze the upper tire mold against the lower tire mold; pumping curing media inside the upper and lower tire molds to provide pressure and temperature to cure the tire; retracting the first and second hollow cylinders post-curing; determining a distance between the height adjustment grooves of the first column and the clamping plates of the first lock assembly; determining a distance between the height adjustment grooves of the second column and the clamping plates of the second lock assembly; actuating a first control means to disengage the clamping plates from the height adjustment grooves of the first column when a predetermined distance is sensed by the first distance sensor, and actuating a second control means to disengage the clamping plates from the height adjustment grooves of the second column when a predetermined distance is sensed by the second distance sensor.

These and other aspects will be apparent from the following detailed description. In no event, however, should this brief summary be construed to limit the claimable subject matter.

### BRIEF DESCRIPTION OF THE DRAWINGS

The disclosed embodiments may be better understood by referring to the figures, in which like reference numerals refer to identical or functionally-similar elements throughout the separate views, further illustrate the present invention and, together with the detailed description of the invention, serve to explain the principles of the present invention.

FIG. 1 is a schematic view of a tire curing press in open condition according to some embodiments;

FIG. 2 is a schematic view of a tire curing press in closed condition according to some embodiments;

FIG. 3 is a schematic cross-sectional view of a tire curing press in open condition according to some embodiments;

FIG. 4 is a schematic cross-sectional view of a tire curing press in closed condition according to some embodiments;

FIG. 5 is a schematic cross-sectional view of the tire curing press during squeeze operation according to some embodiments;

FIG. 6 is a schematic top view showing the closed condition of the locking system of the top structure of the tire curing press according to some embodiments;

FIG. 7 is a schematic top view showing the open condition of the locking system of the top structure of the tire curing press according to some embodiments;

FIGS. 8a-8d is a schematic cross-sectional view of the tire curing press in various locking positions according to some embodiments;

FIG. 9 is a schematic cross-sectional view of the tire curing press in closed condition showing the pressure development during curing process according to some embodiments;

FIG. 10 shows schematic cross-sectional views of the tire curing press in closed condition showing prevention of bladder burst due to mold opening gap according to some embodiments;

FIG. 11 schematically shows a pneumatic circuit diagram for independent lock/unlock operation of the locking system according to some embodiments;

FIG. 12 schematically shows a hydraulic circuit diagram for independent squeeze column movement according to some embodiments; and

FIG. 13 is a schematic side view of the tire curing press according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

The present disclosure relates to a tire curing press apparatus for shaping and curing tires with a hydraulic cylinder arrangement. The tire curing press relates to a class of industrial machinery which presents an opportunity to provide heating media with high pressure such as hot water, steam or nitrogen that are internally applied into a curing bladder pushing a green (uncured) tire circumferentially outwards, towards the edges of the mold by stretching the bladder. Meanwhile, the mold is heated from outside on a top and bottom surface by heating platens. Thus, the tire takes the shape within the confines of the mold under pressure and temperature for predefined time period. Hence the apparatus has in its structure the provision to secure tire molds which forms the cured tire.

The tire curing press has provisions to support or mount auxiliary sub-assemblies that helps load, i.e. to place a green tire into the mold, and to unload, i.e., to remove the cured tire from the mold. The tire curing press apparatus is also capable of adjusting the mold height to accommodate varying range of mold sizes for curing different sizes of tires within the same tire press. One of the challenges in existing devices is that, post curing, the unlocking of the top structure lock assembly from grooves in the squeeze columns does not happen efficiently. These and other challenges are addressed by embodiments disclosed herein.

The disclosure provides a device and method for tire mold height adjustment to accommodate a varying range of mold sizes helping the user to cure different sizes of tires within the same tire curing press. The linear displacement of the top structure which holds the upper mold is done by a plurality of hydraulic cylinders, guided by guide columns having multiple height adjustment grooves to facilitate the locking of the top structure at different heights and to accommodate tire molds of different sizes. The external hydraulic pressure on the upper and lower tire molds is applied with the help of hollow squeeze cylinders which are mounted at the bottom of the guide columns. The locking/unlocking of the top structure, actuation of hollow squeeze cylinders and sensing of guide column position are done using independent hydraulic and pneumatic circuits which enables accurate positioning of the guide columns and the top structure for smooth locking and unlocking operations without causing damage to the guide columns or the locking assembly.

Different embodiments will now be discussed with reference to various schematic and exemplary illustrations in the accompanying figures.

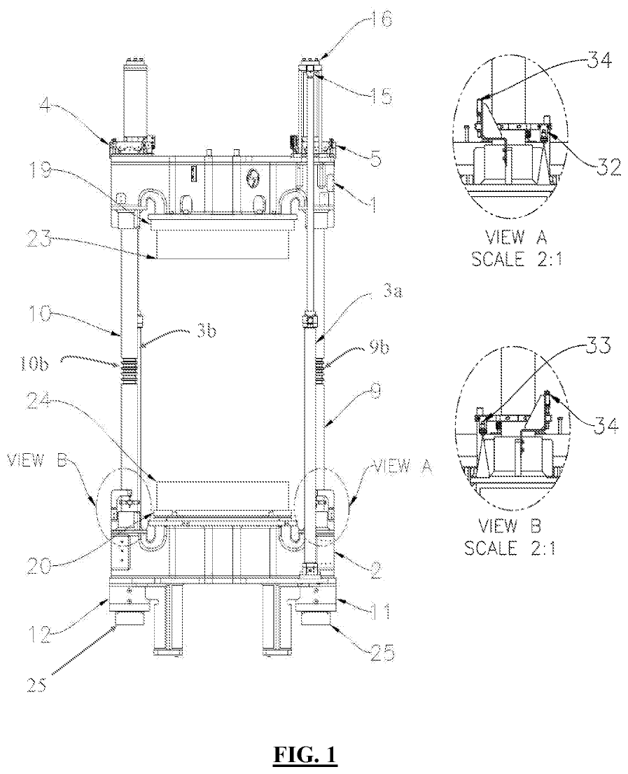

FIGS. 1-5 show different views of a hydraulic tire curing press in open and closed conditions. The tire curing press includes a movable top structure (1) and a rigid bottom structure (2). For instance, the bottom structure (2) can be fixed to the floor by means of fasteners. The bottom structure (2) includes cavities and provisions for mounting various components and sub-systems of the tire curing press. The bottom structure (2) includes at least two cavities (not shown) for mounting first and second columns (9, 10). A first hollow cylinder (11) can be mounted below the bottom structure (1), and a second hollow cylinder (12) can be mounted below the bottom structure (1) at a fixed distance from the first hollow cylinder (11). Each of the first and second hollow cylinders (11, 12) can be fastened at the bottom of the bottom structure (2) concentric to the corresponding cavity provided for the mounting of the first and second columns (9, 10).

The first and second hollow cylinders (11, 12) can be mounted on the underside of the bottom support (2) by a plurality of suitable mechanical fasteners. The first and second hollow cylinders (11, 12) can be extended during curing of the tire and retracted post-curing of the tire. In some embodiments, the first and second hollow cylinders (11, 12) can be hydraulic squeeze cylinders that can be configured to apply a substantially equal squeeze pressure to a movable platen to thereby establish a final tire curing pressure within the press cavity.

The first column (9) has a lower end mounted inside a first hollow piston (13) that can be slidably mounted inside the first hollow cylinder (11). The second column (10) has a lower end mounted inside a second hollow piston (14) that can be slidably mounted inside the second hollow cylinder (12). The first and second columns (9, 10) may be vertical cylindrical squeeze columns which connects both the top structure (1) and the bottom structure (2). The top structure (1) is capable of sliding along the first and second columns (9, 10) in a vertical direction towards or away from the bottom structure (2). The vertical sliding movement of the top structure (1) is facilitated by a first lift cylinder (3a) and a second lift cylinder (3b). The first and second lift cylinders (3a, 3b) are capable of extending and retracting to slidably move the top structure (1) along the first and second columns (9, 10) in a direction towards or away from the bottom structure (2), respectively. The lift cylinders (3a, 3b) are mounted to the bottom structure (2) at one end and have an opposite connecting rod end connected to the top structure (1) by a rod end retainer (15). The first and second lift cylinders (3a, 3b) are assembled to the bottom structure (2) at a fixed distance from each other.

The columns (9, 10) can be erected over the bottom structure (2) with a bush arrangement (22) and the base of the columns (9, 10) can be fastened with a holding means (25) by interlocking fastening grooves (9c) machined in the bottom of the columns and the rod holder (25) and fastening by a plurality of bolts and washers. The holding means (25) is also assembled to the hollow pistons (13, 14) by means of fasteners. In some cases, a first holding means (25) secures the lower end of the first column (9) with the first hollow piston (13), and a second holding means (25) secures the lower end of the second column (10) with the second hollow piston (14).

An upper tire mold (23) is fixed on an upper tire mold platen (19) and assembled to the top structure (1). A lower tire mold (24) is fixed on a lower tire mold platen (20) and assembled to the bottom structure (2). During the tire curing process, the top structure (1) is pulled downward and the upper tire mold (23) is squeezed against the lower tire mold (24) when hydraulic pressure is created in the at least two hollow cylinders (11, 12).

The top of the first and second columns (9, 10) includes a step portion (9a, 10a) to lock the top structure (1) during the fully open position of the tire curing press. Height adjustment grooves (9b, 10b) are formed at an intermediate position on each of the first and second columns (9, 10). The height adjustment grooves (9b, 10b) facilitates locking of the top structure (1) at different vertical positions to obtain variable heights between the top (1) and bottom (2) structures during closed condition of the press and to accommodate different sizes of tire molds.

The first and the second columns (9, 10) may also include a further groove between the step portion (9a, 10a) and intermediate grooves (9b, 10b) to mount a split-ring (16). The further groove may be positioned in a way to facilitate the locking of the columns (9, 10) by the split-rings (16) over the bottom structure (2), when the rod holder (25) is removed.

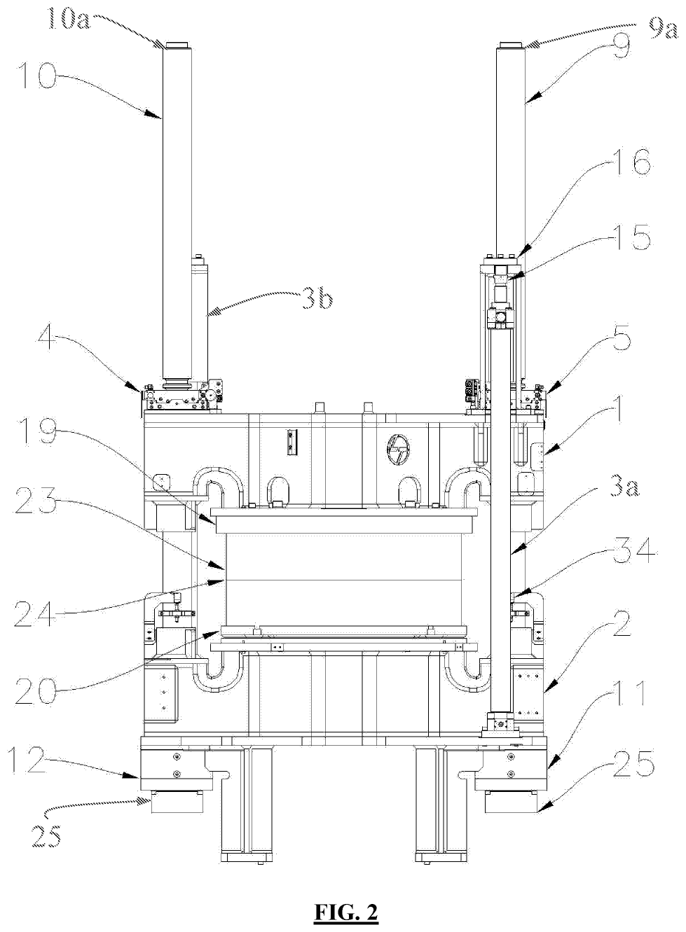

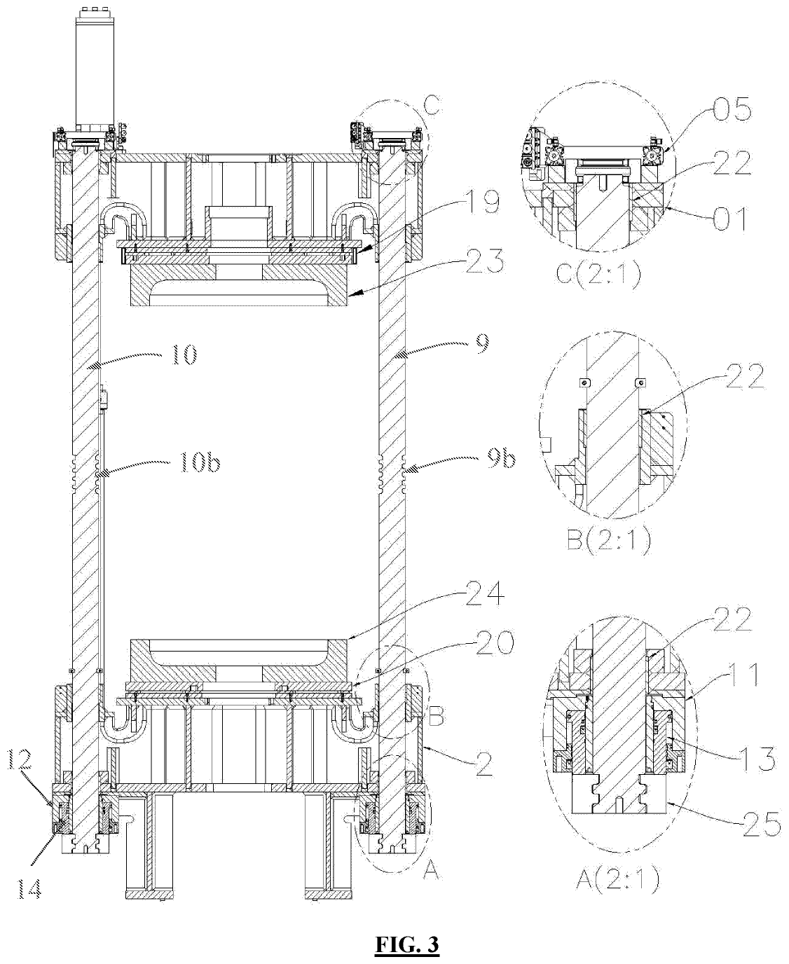

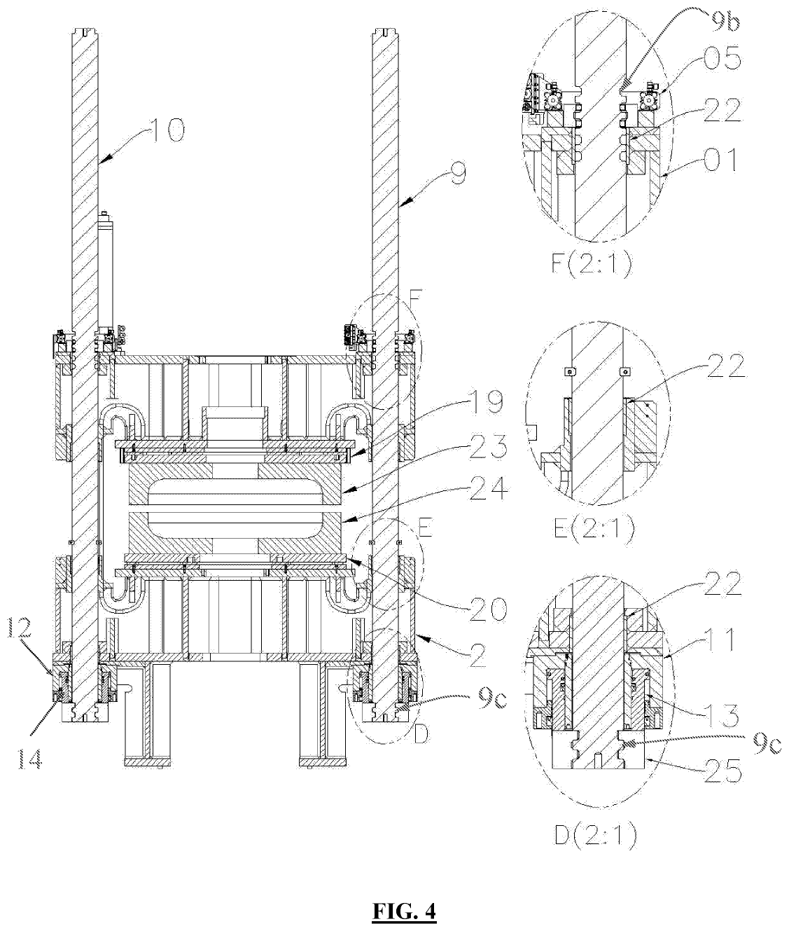

The open condition of the press as shown in FIGS. 1 and 3 occurs when the lift cylinders (3a, 3b) are fully extended, and the top structure (1) is locked either at the step portion (9a, 10a) or at a desired location by means of a lock assembly (4, 5). The closed condition of the press as shown in FIGS. 2 and 4 occurs when the lift cylinders (3a, 3b) are retracted, positioning the top structure (1) at the required position and locking it to the height adjusting grooves (9b, 10b) of the squeeze columns (9,10) by means of lock assembly (4,5).

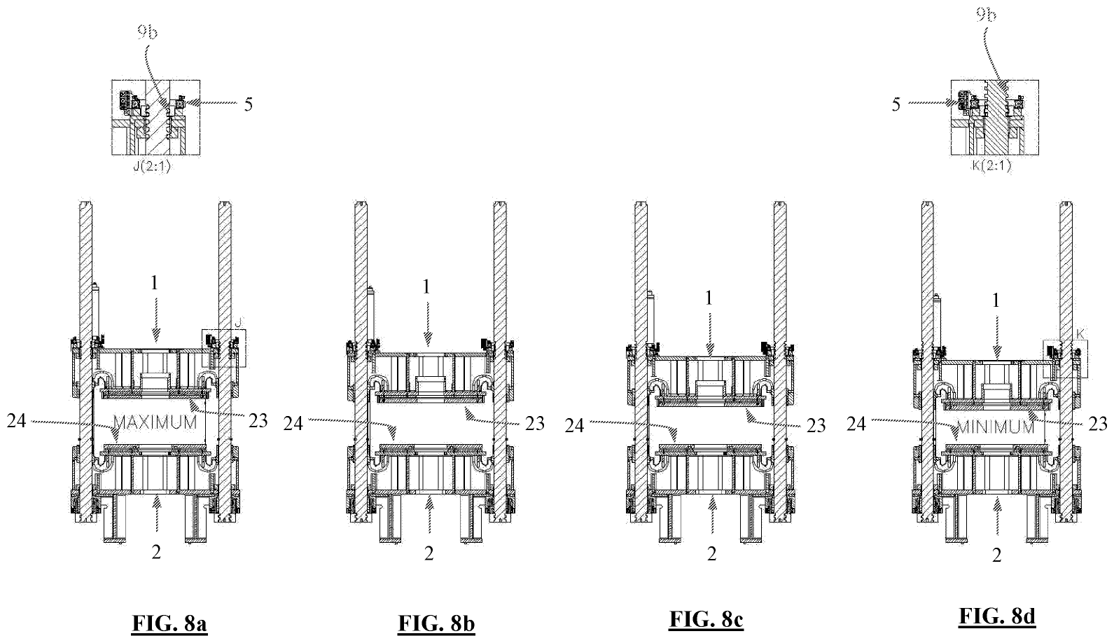

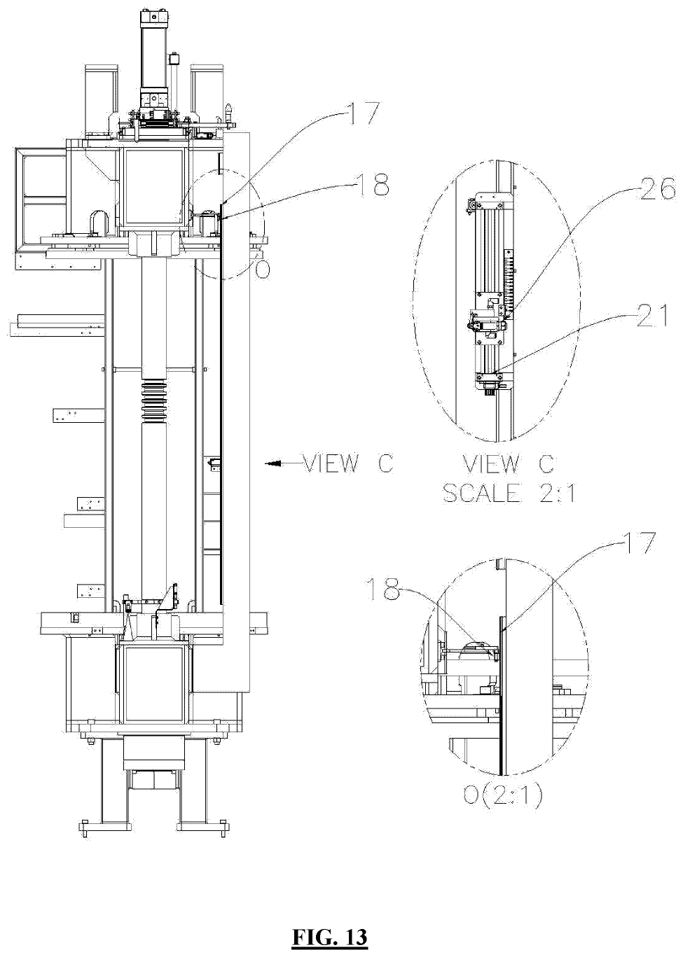

As best shown in FIGS. 8a-8d, molds (23,24) of different heights can be used in a single tire curing press, by altering the distance between both the top (1) and bottom (2) structures, which is achieved by locking the top structure (1) to different intermediate grooves (9b, 10b) of the first and second columns (9,10). As shown in FIG. 13, the stopping position for the top structure (1) can be adjusted with the help of a mold height setting mechanism (21) that includes an adjustable mold height switch (26) with an adjacent scale showing the corresponding mold height values. The position of the sliding top structure (1) can be sensed by means of a sensor setup. The sensor setup may include a linear displacement sensor (17) fixed to the bottom structure (2) and a sensor magnet (18) fixed to the top structure (1) to provide a position of the sliding top structure (1) at any given instant. The linear displacement sensor (17) may be a Linear Variable Differential Transformer (LVDT) in some embodiments.

In some aspects, as shown in FIG. 1, one or more limit switches (34) is mounted above the bottom structure (2), to sense the position of the first and second hollow pistons (13,14) inside the first and second hollow cylinders (11,12).

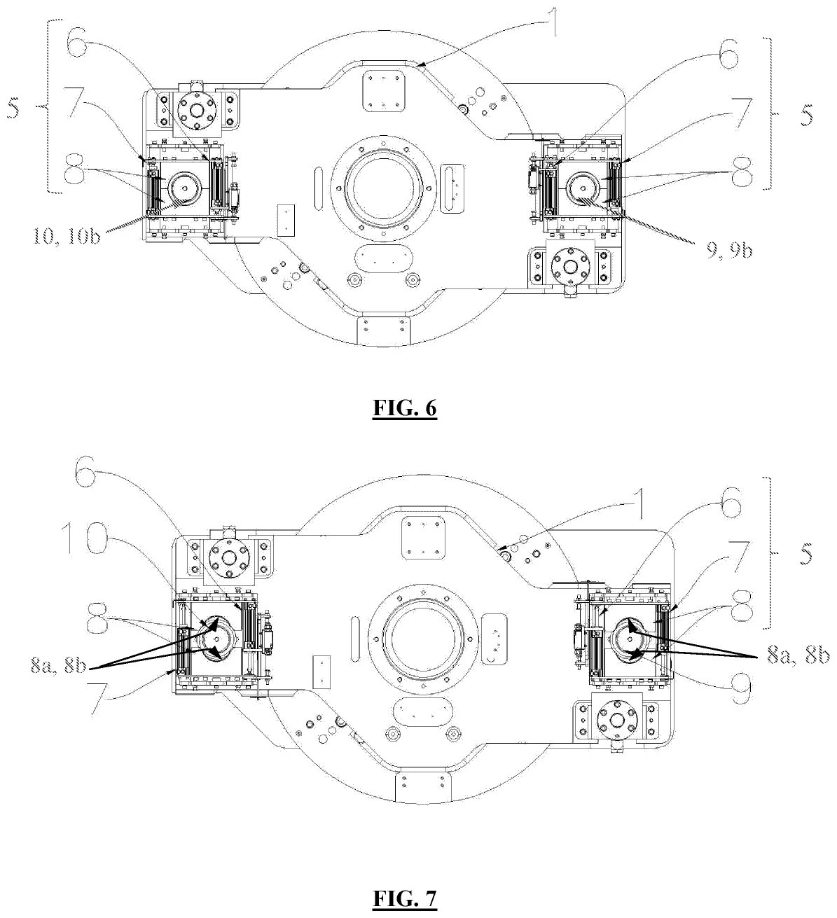

As best shown in FIGS. 1 and 2, lock assemblies (4, 5) are assembled concentric to respective columns (9, 10) by suitable fasteners. The lock assemblies (4, 5) are responsible for locking the top structure (1) over the squeeze columns (9, 10) in a desired position. In some aspects, a first lock assembly (5) is assembled concentric to the first column (9) above the top structure (1) and a second lock assembly (4) is assembled concentric to the second column (10) above the top structure (1). As shown in FIGS. 6 and 7, in some embodiments, each of the first and second lock assemblies (4, 5) includes at least two clamping plates (8) capable of being pulled towards each other to engage with the height adjustment grooves (9b, 10b) and to lock the top structure (1) with the first and second columns (9, 10) during curing. In some aspects, each clamping plate (8) may include a semicircle cut-out (8a) and an inner groove (8b), such that pulling the clamping plates (8) towards each other engages the semicircle cut-out (8a) and the inner groove (8b) to at least two of the height adjustment grooves (9b, 10b).

Each of the first and second lock assemblies (4, 5) include at least one lock cylinder (6, 7) capable of being independently actuated to either engage or disengage the clamping plates (8) to/from the height adjustment grooves (9b, 10b). The lock cylinders (6, 7) in some cases may be pneumatic/hydraulic cylinders.

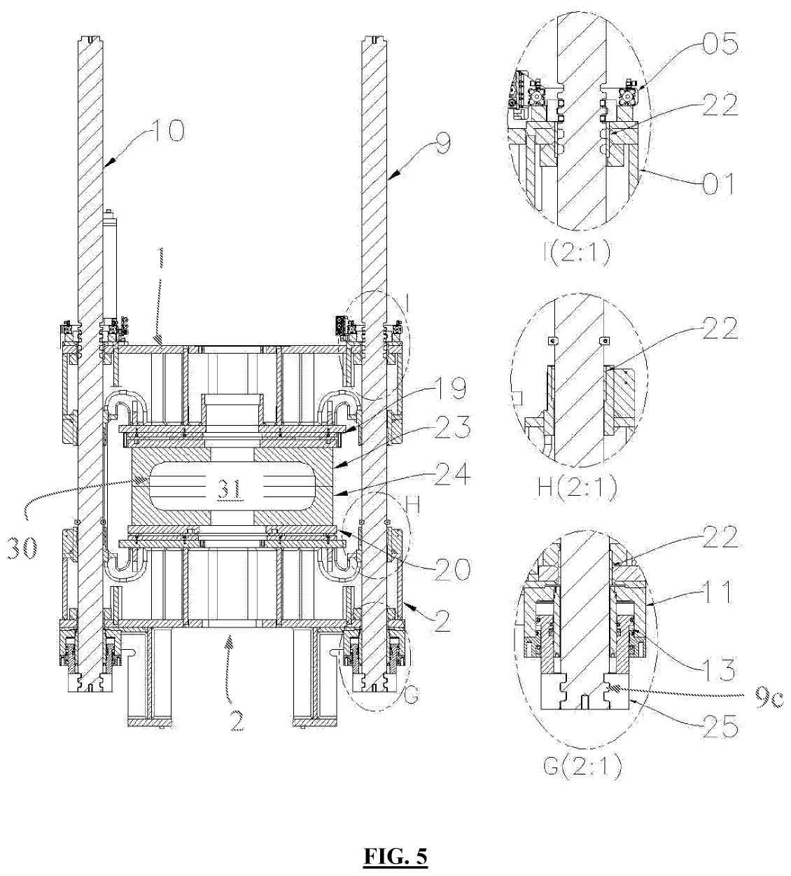

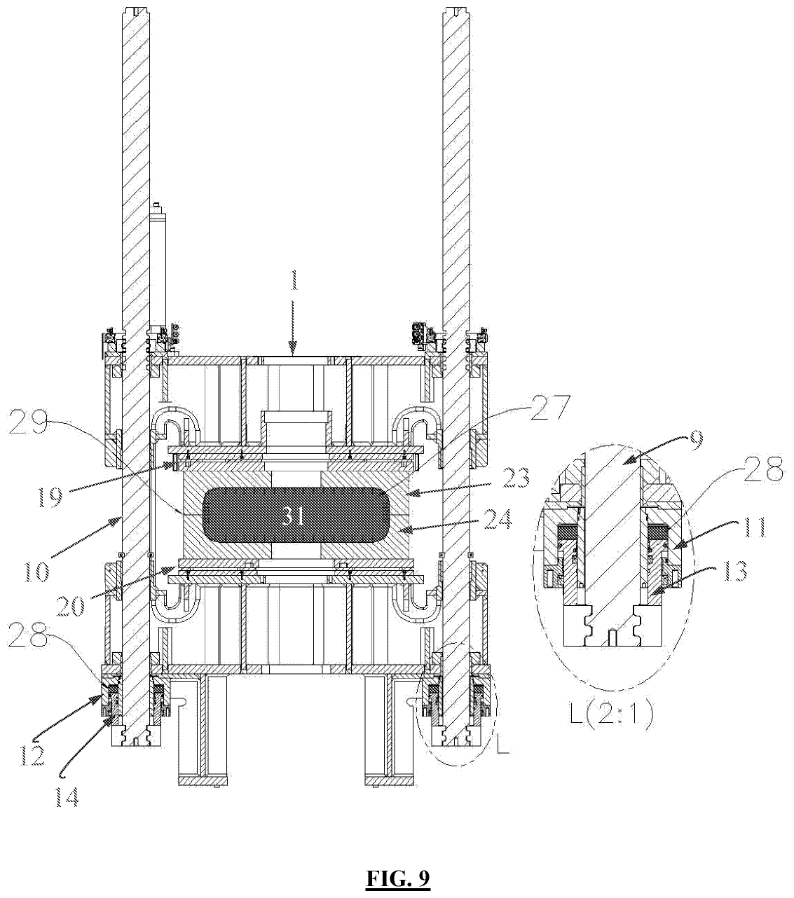

As shown in FIGS. 5 and 9, during the tire curing process, the first and second hollow squeeze cylinders (11,12) are pumped with hydraulic fluid, creating a hydraulic oil pressure (28) along the inner walls of the hollow squeeze cylinders (11,12) thereby pushing the first and second hollow pistons (13,14) downwards. The extended pistons (13, 14) pull the squeeze columns (9, 10) and the top structure (1) downwards, thus squeezing the upper tire mold (23) against the rigid bottom tire mold (24). In this condition, curing pressure (27) is developed inside the molds (23, 24), by pumping curing media, such as nitrogen, steam, hot water or the like inside the upper and lower tire molds (23,24) to provide the desired pressure and temperature to the uncured tire (31), thus curing the tire. These upper and lower tire mold platens (19, 20) include inner cavities through which the curing media flows during the curing process, thus heating the upper and lower molds (23,24) fixed to it. The curing pressure acts on both the upper and lower tire molds (23, 24), in which the lower tire mold (24) is held rigidly by the bottom structure (2) and the upper tire mold (23) is pulled downwards by the hydraulic oil pressure (28) developed inside the hollow squeeze cylinders (11, 12), which provides the counter acting force to contain the curing pressure (27).

Application of hydraulic pressure (28) is to prevent the upper and lower tire molds (23, 24) from opening when the curing pressure (27) is developed between the molds during curing. The curing pressure (27) developed inside the molds are often high, which can cause serious disaster if the upper and lower tire molds (23, 24) accidentally opens during the curing condition.

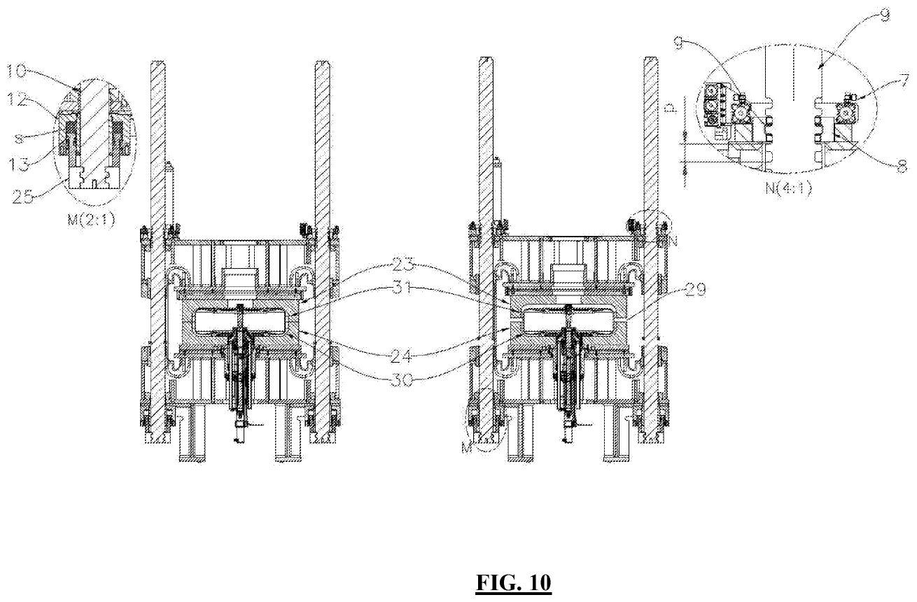

Referring to FIG. 10, in the event the hydraulic pressure (28) becomes lesser than a predetermined value due to failure of the hydraulic system, a predetermined mold opening gap (29) is achieved between the upper tire mold (23) and the lower tire mold (24). In some aspects, the predetermined mold opening gap (29) is maintained by setting a stroke length S of the first and/or the second hollow pistons (13, 14) and a pitch distance P between the height adjustment grooves (9b, 10b), such that S>P. The predetermined mold opening gap (29), in some instances, is maintained at about 0 to 60 mm, or between 30 to 55 mm, or at about 50 mm, which is achieved by limiting the stroke length S of the piston (13,14) to about 0 to 60 mm, or between 30 to 55 mm, or about 50 mm, and limiting the pitch distance P between the height adjustment grooves (9b, 10b) of the first and second column (9,10) to be lesser than the stroke length S of the piston (13,14). Thus even if the hydraulic pressure (28) becomes lesser than a predetermined value due to, say, failure of the hydraulic system leading to opening of the tire molds (23, 24), the upper tire mold (23) can open only to a maximum of 50 mm, thus providing enough support to the expanding inflatable bladder (30) and preventing it from further expansion and bursting or damaging the green tire (31) and ensuring a safe operating environment. The detailed view in FIG. 10 shows the available gap (g) between the clamp plates (8) and the first and second columns (9, 10), which is less when compared to the stroke length of the pistons (13, 14).

In some embodiments, hydraulic and pneumatic circuits configured to enable the operation of the tire curing press during open and closed conditions of the molds. The configuration of the hydraulic and pneumatic circuits will be described with reference to FIGS. 1, 11 and 12. In some aspects, as shown in FIG. 1, distance sensors (32, 33) are provided on, or in the vicinity of, the first and second columns (9, 10). In some cases, a first distance sensor (32) determines a gap (g) between the height adjustment grooves (9b) of the first column (9) and the clamping plates (8) of the first lock assembly (5) when the first hollow cylinder (11) is retracted post-curing of the tire. A second distance sensor (33) determines a distance between the height adjustment grooves (10b) of the second column (10) and the clamping plates (8) of the second lock assembly (4) when the second hollow cylinder (12) is retracted post-curing of the tire.

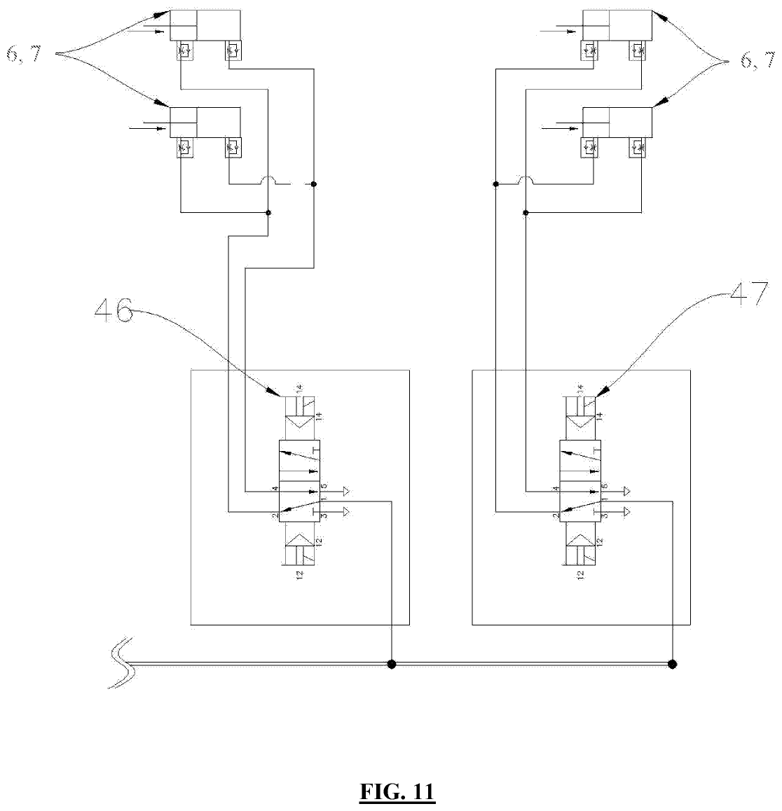

In some embodiments, the pneumatic circuit as shown in FIG. 11, includes a first control means (46) to disengage the clamping plates (8) of the first lock assembly (5) from the height adjustment grooves (9b) of the first column (9) when a predetermined distance is sensed by the first distance sensor (32). The clamping plates (8) are disengaged when the first control means (46) actuates the corresponding pneumatic/hydraulic lock cylinder (6, 7) of the first lock assembly (5). The pneumatic circuit further includes a second control means (47) to disengage the clamping plates (8) of the second lock assembly (4) from the height adjustment grooves (10b) of the second column (10) when a predetermined distance is sensed by the second distance sensor (33). The clamping plates (8) are disengaged when the second control means (47) actuates the corresponding pneumatic/hydraulic lock cylinder (6, 7) of the second lock assembly (4).

In some embodiments, the first and second control means (46, 47) can be independently actuated to independently disengage the clamping plates (8) of the first and second lock assemblies (5, 4) from corresponding height adjustment grooves (9b, 10b) of the first and second columns (9, 10). During operation, the post-curing retraction of the first hollow cylinder (11) moves the first column (9). This movement is sensed by the first distance sensor (32), and when sufficient gap is sensed by the first distance sensor (32), the corresponding control means (46) is actuated to unlock the clamp plate (8) for that corresponding column (9). Similarly, retraction of the second hollow cylinder (12) moves the second column (10). This movement is sensed by the second distance sensor (33), and when sufficient gap is sensed by the second distance sensor (33), the corresponding control means (47) is actuated to unlock the clamp plate (8) for that corresponding column (10).

This arrangement allows to separately unlock each lock assembly (5, 4) based on the feedback received from the corresponding distance sensor (32, 33) and prevents partial unlocking or jamming of the clamp plates (8) with the grooves (9b, 10b) on each column (9, 10).

The first and second control means (46, 47) may be directional flow control valves (FCV). Such FCVs may include solenoid valves, preferably 5/2 double solenoid valves.

The operation of the tire curing press will now be explained with reference to FIGS. 1 to 11. An uncured tire (31) is positioned between an upper tire mold (23) and the lower tire mold (24). The tire curing press is closed and locked by lowering the top structure (1) and engaging the clamping plates (8) of the first and second lock assemblies (4, 5) to the corresponding height adjustment grooves of the first and second column (9,10). Hydraulic liquid, such as oil, pumped into the first and second hollow cylinders (11, 12) creates hydraulic pressure (28) along inner walls of the cylinders (11, 12), pushes the first and second hollow pistons (13, 14) downward, and pulls the first and second columns (9,10) and the top structure (1) downwards to squeeze the upper tire mold (23) against the lower tire mold (24). Subsequently, curing media is pumped inside the upper and lower tire molds (23, 24) to provide pressure and temperature to cure the tire (31) and the upper and lower molds are heated from outside by heating platens and on the circumference by heating jackets in the mold resulting in the tire taking the shape within the confinement of the mold under appropriate pressure and temperature for a predefined time period. The curing temperature may be about 150-200° C. and the curing pressure may be about 320 to 360 PSI.

Upon completion of curing, the first and second hollow cylinders (11, 12) are retracted by steadily reducing the hydraulic flow using appropriate flow control valves (35,45). The distance between the height adjustment grooves (9b, 10b) of the first and second columns (9, 10) and the clamping plates (8) of the first and second lock assemblies (5, 4) are determined by using distance sensors (32, 33). When a predetermined distance is sensed by the distance sensors (32, 33) the control means (46, 47) are actuated to disengage the clamping plates (8) from the height adjustment grooves (9b, 10b) of the column (9, 10). The first and second control means (46, 47) are independently actuatable upon receiving feedback from the corresponding distances sensors (32, 33). For instance, the lock cylinders (6, 7) may be independently actuated by the control means (46, 47) to disengage the clamping plates (8) from the respective height adjustment grooves (9b, 10b).

A predetermined mold opening gap (29) is maintained between the upper tire mold (23) and the lower tire mold (24) if the hydraulic oil pressure (28) is lesser than a predetermined value by setting a stroke length S of the first and/or the second hollow pistons (13, 14) and a pitch distance P between the height adjustment grooves (9b, 10b), such that S>P.

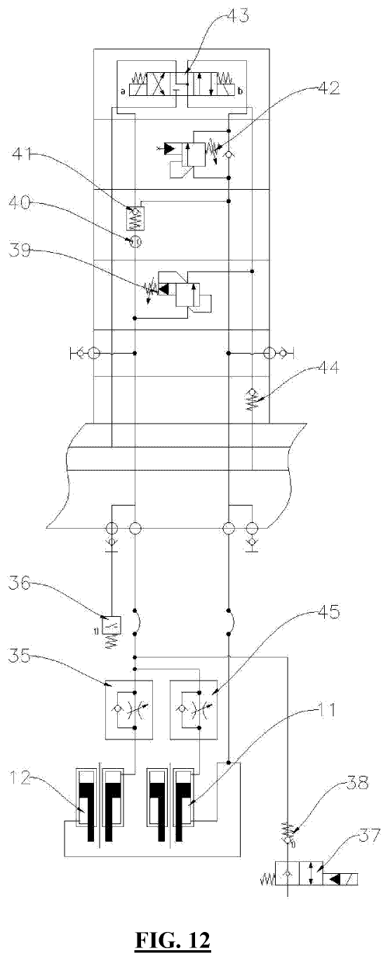

As shown in FIG. 12, the hydraulic circuit includes separate flow control valves (45, 35) to independently control the speed of corresponding first and second hollow cylinders (11,12) through which movement of the corresponding columns (9,10) is controlled. In some cases, the flow control valves (45, 35) may be meter-out flow control valves, for example. Actuation means (43) may be provided for actuating the first and second hollow cylinders (11, 12) to extend or retract the first and second columns (9, 10). Speed or flow control of first and second hollow cylinders (11,12) is independent, through flow control valves (35,45). In some cases, the actuation means (43) may be a double solenoid DC valve. A position retaining means (42) may be included in the hydraulic circuit to hold the first and second columns (9, 10) in their extended or retracted positions. The position retaining means (42) may be a counterbalance valve arranged between the actuation means (43) and the flow control valves (45, 35).

Further, the hydraulic circuit may include a pressure retaining means (41) arranged between the flow control valves (45, 35) and the actuation means (43) to maintain the pressure in the first and/or second hollow cylinders (11, 12). A pressure control means (40) may be arranged between the pressure retaining means (41) and the flow control valves (45, 35) to steadily reduce the pressure release during retraction of the first and/or second hollow cylinders (11, 12). In some instances, the pressure retaining means (41) may be a check valve and the pressure control means (40) may be an orifice disc. A pressure relief valve (39) is included in the hydraulic circuit as a safety valve to ensure that the pressure in the first and/or second hollow cylinders (11, 12) does not exceed a predetermined limit. The hydraulic circuit includes a backflow preventer means (44) to ensure that a backpressure does not affect the position of the first and/or second hollow cylinders (11, 12). The backflow preventer means (44) may be a check valve arranged between the flow control valves (45, 35) and the actuation means (43) to ensure that the pressure in the return lines does not affect the position of the cylinders (11, 12). Further, a pressure control valve (37) is included in the hydraulic circuit between a hydraulic pressure source (not shown) and the flow control valves (45, 35) to increase the hydraulic pressure in the first and/or second hollow cylinders (11, 12). The pressure control valve (37) may be a single solenoid poppet DC valve, for example. A backflow prevention valve (38) may be provided between the pressure control valve (37) and the flow control valves (45, 35). A pressure sensor (36) may be provided to monitor the pressure within the hydraulic circuit.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. A tire curing press, comprising:
a top structure,
a bottom structure,
a first hollow cylinder mounted below the bottom structure and capable of being extended during curing and retracted post-curing of a tire,
a second hollow cylinder mounted below the bottom structure at a fixed distance from the first hollow cylinder, and capable of being extended during curing and retracted post-curing of a tire,
a first column having a lower end mounted inside a first hollow piston slidably mounted inside the first hollow cylinder,
a second column having a lower end mounted inside a second hollow piston slidably mounted inside the second hollow cylinder; wherein the top structure is capable of sliding along the first and second columns in a direction towards or away from the bottom structure,
height adjustment grooves formed at an intermediate position on each of the first and second columns to obtain variable heights between the top and bottom structures and to accommodate different sizes of tire molds,
a first lock assembly assembled concentric to the first column above the top structure,
a second lock assembly assembled concentric to the second column above the top structure,
each of the first and second lock assemblies comprises clamping plates capable of being pulled towards each other to engage with the height adjustment grooves and to lock the top structure with the first and second columns during curing,
a first distance sensor to determine a distance between the height adjustment grooves of the first column and the clamping plates of the first lock assembly when the first hollow cylinder is retracted post-curing of the tire,
a second distance sensor to determine a distance between the height adjustment grooves of the second column and the clamping plates of the second lock assembly when the second hollow cylinder is retracted post-curing of the tire,
a first control means to disengage the clamping plates from the height adjustment grooves of the first column when a predetermined distance is sensed by the first distance sensor, and
a second control means to disengage the clamping plates from the height adjustment grooves of the second column when a predetermined distance is sensed by the second distance sensor.

2. The tire curing press according to claim 1, wherein the first and second control means are independently actuated.

3. The tire curing press according to claim 1, further comprising an upper tire mold fixed on an upper tire mold platen and assembled to the top structure, and a lower tire mold fixed on a lower tire mold platen and assembled to the bottom structure, wherein the top structure is pulled downward and the upper tire mold is squeezed against the lower tire mold when a hydraulic pressure is created in the at least two hollow cylinders.

4. The tire curing press according to claim 3, wherein a predetermined mold opening gap is maintained between the upper tire mold and the lower tire mold if the hydraulic oil pressure is lesser than a predetermined value.

5. The tire curing press according to claim 4, wherein the predetermined mold opening gap is maintained by setting a stroke length S of the first and/or the second hollow pistons and a pitch distance P between the height adjustment grooves, such that S>P, where max. value of gap is maintained at about 0 to 60 mm, and the predetermined mold opening gap is maintained at about 0 to 60 mm.

6. (canceled)

7. The tire curing press according to claim 1, further comprising:
a first lift cylinder assembled to the bottom structure,
a second lift cylinder assembled to the bottom structure at a fixed distance from the first lift cylinder,
a connecting rod end of each of the first and second lift cylinders is connected to the top structure by a rod end retainer,
wherein the first and second lift cylinders are capable of extending and retracting to slidably move the top structure along the first and second columns in a direction towards or away from the bottom structure, respectively.

8. The tire curing press according to claim 1, wherein each of the first and second lock assemblies comprises at least one lock cylinder, capable of being independently actuated to engage or disengage the clamping plates to/from the height adjustment grooves.

9. (canceled)

10. The tire curing press according to claim 1, wherein a linear displacement sensor is fixed to the bottom structure and a sensor magnet is fixed to the top structure to provide a position of the sliding top structure at any given instant.

11. The tire curing press according to claim 1, wherein at least one limit switch is mounted above the bottom structure, to sense the position of the first and second hollow pistons inside the first and second hollow cylinders.

12. The tire curing press according to claim 1, wherein the first and second control means are directional control valves.

13. The tire curing press according to claim 1, further comprising:
an actuation means for actuating the first and second hollow cylinders to extend or retract the first and second columns;
a position retaining means to hold first and second columns in their extended or retracted positions;
a pressure retaining means to maintain the pressure in the first and/or second hollow cylinders;
a pressure control means to steadily reduce the pressure release during retraction of the first and/or second hollow cylinders;
a pressure relief valve to ensure that the pressure in the first and/or second hollow cylinders does not exceed a predetermined limit;
a backflow preventer means to ensure that a backpressure does not affect the position of the first and/or second hollow cylinders; and
a pressure control valve actuated to increase the pressure in the first and/or second hollow cylinders, said pressure control valve is connected to a hydraulic pressure source.

14. (canceled)

15. (canceled)

16. (canceled)

17. (canceled)

18. (canceled)

19. The tire curing press according to claim 1, comprising at least one mold height setting mechanism having an adjustable mold height switch placed on the bottom structure to adjust the stopping position of the top structure.

20. The tire curing press according to claim 3, wherein a curing pressure is developed inside the upper and lower tire molds by pumping fluid media inside the upper and lower tire molds to provide appropriate pressure and temperature to cure the tire.

21. The tire curing press according to claim 1, comprising a first flow control means to control the speed of the first hollow cylinder, and a second flow means to control the speed of the second hollow cylinder.

22. The tire curing press according to claim 1, wherein each clamping plate comprises a semicircle cut-out and an inner groove, such that pulling the clamping plates towards each other engages the semicircle cut-out and the inner groove to at least two of the height adjustment grooves.

23. The tire curing press according to claim 1, comprising a first holding means to secure the lower end of the first column with the first hollow piston, and a second holding means to secure the lower end of the second column with the second hollow piston.

24. A method for vulcanizing tires using the tire curing press according to claim 1 comprising:
positioning an uncured tire between an upper tire mold and a lower tire mold of a tire curing press;
closing the tire curing press by lowering the top structure and engaging the clamping plates of the first and second lock assemblies to the height adjustment grooves of the first and second column;
creating a hydraulic pressure along inner walls of the first and second hollow cylinders to push first and second hollow pistons downward and pull the first and second columns and the top structure downwards to squeeze the upper tire mold against the lower tire mold;
pumping curing media inside the upper and lower tire molds to provide pressure and temperature to cure the tire;
retracting the first and second hollow cylinders post-curing;
determining the distance between the height adjustment grooves of the first column and the clamping plates of the first lock assembly;
determining the distance between the height adjustment grooves of the second column and the clamping plates of the second lock assembly;
actuating the first control means to disengage the clamping plates from the height adjustment grooves of the first column when a predetermined distance is sensed by the first distance sensor, and
actuating the second control means to disengage the clamping plates from the height adjustment grooves of the second column when a predetermined distance is sensed by the second distance sensor.

25. The method according to claim 24, comprising the step of independently actuating the first and second control means.

26. The method according to claim 24, comprising the step of maintaining a predetermined mold opening gap between the upper tire mold and the lower tire mold if the hydraulic oil pressure is lesser than a predetermined value, the gap being maintained by setting a stroke length S of the first and/or the second hollow pistons and a pitch distance P between the height adjustment grooves, such that S>P.

27. (canceled)

28. The method according to claim 26, comprising the step of independently actuating at least one lock cylinder to engage or disengage the clamping plates to/from the height adjustment grooves.
